(19) United States
(12) Patent Application Publication
(10) Pub. No.: US 2017/0256899 A1
(43) Pub. Date: Sep. 7, 2017

(54) System and Method for Providing Marine Shore Power

(71) Applicant: Vincent Mitchell, Helena, MT (US)

(72) Inventor: Vincent Mitchell, Helena, MT (US)

(21) Appl. No.: 15/448,593

(22) Filed: Mar. 3, 2017

Related U.S. Application Data
(60) Provisional application No. 62/302,404, filed on Mar. 2, 2016.

(51) Int. Cl. H01R 33/76; H01R 33/90; H02J 3/00

(52) U.S. Cl. CPC H01R 33/7607; H02J 3/00; H01R 33/7664; H01R 33/90; H01R 2201/26; B63J 2003/043

(57) ABSTRACT

A system for providing marine shore power to a vessel regardless of the configuration of the shore power source or the configuration of any socket installed on the shore power source is disclosed. A vessel plug, which is intended to be installed on a vessel's shore power cable, has a male adapter component which accepts a plurality of adapters. The plurality of adapter each have a female socket component and a male adapter component. The male plug component of the vessel plug is compatible with and plugs into the female socket component of each of the plurality of adapters. Each of the male adapter components of the plurality of components are each configured differently so as to enable a vessel to connect to a shore power source regardless of the configuration of the shore power source or the configuration of any socket installed on the shore power source.

### CLAIM OF PRIORITY

This application claims the benefit of U.S. Provisional Application No. 62/302,404, filed Mar. 2, 2016, the entire disclosures of which are incorporate herein by reference.

### STATEMENT CONCERNING FEDERALLY SPONSORED RESEARCH OR DEVELOPMENT

Not applicable.

### BACKGROUND OF THE INVENTION

Field of the Invention

The present invention pertains generally to a marine shore power multi-adapter that utilizes three-phase power service. More particularly, the invention relates to a marine shore power plug adapter system and method that enables the power system of a boat, yacht or marine vessel to connect to any variety of three-phase shore power sources found throughout the world.

Description of the Prior Art

Adapters for different types of electrical power supplies have been known in the prior art since the dawn of the modern power grid and improvements to the art are frequently provided. A relatively old example is provided by R. W. Rumble, entitled “Electrical Plug,” U.S. Pat. No. 3,079,475, which was awarded patent protection in 1960. According to Rumble, his invention relates to electrical fittings which can be adjusted by the user to fit any one of a multiplicity of electrical sockets, which may be made to receive plugs having either two or three pins.

Yet another relatively old example is provided by Jean-Daniel Hugly, entitled “Plug For Voltage Adaptation,” U.S. Pat. No. 3,996,546, which was awarded patent protection in 1976. According to Hugly, his invention relates to an electrical plug, more particularly a dual-voltage electrical plug which is adaptable to connect an appliance such as an electric shaver alternatively to sockets belonging to either one of two main supplies of differing voltage.

A relatively newer example is provided by Schneider et al., entitled “In-Line AC Adapter for Camping and Marine Electrical Service,” U.S. Pat. No. 6,929,515, which was awarded patent protection on Aug. 16, 2005. According to Schneider et al., their invention relates to interfacing differing electrical systems, and, in particular, to an adapter for connecting electrical lines of dissimilar terminal configurations.

Yet one more example is provided by Walliser and Mazieres, entitled “Power Adapter With Interchangeable Heads,” U.S. Pat. No. 8,708,722, which was awarded patent protection on Apr. 29, 2014. According to Walliser and Mazieres, their invention relates to a power adapter with a cable port disposed on one side and a power conversion circuit to convert an input power from an alternating current (AC) power system to an output power used by a device coupled to the cable port. In addition, the power adapter allows for interchangeable heads, each with prongs suitable for different types of international AC power systems to allow the user to power electronic devices throughout the world with the use of only one power adapter.

Also known in the art are a variety of other related inventions purporting to allow electrical and electronic devices to be powered from a variety of differing types of electrical systems using adapters and/or power converters. Specific examples are too numerous to fully summarize herein.

In light of the above, there is an absence of prior art that pertain to plug adapter systems for providing high amperage three-phase shore power to a marine vessel, regardless of the type of plug configuration used on the shore power supply source. Currently, a range of three-phase sockets are used in marinas throughout the world. IEC 60309, an international standard from the International Electrotechnical Commission for “plugs, socket-outlets and couplers for industrial purposes,” sets standards for many industrial three-phase power sockets and plugs. One of the purposes of IEC 60309 is so that plugs of one type can only be inserted into a socket of the same type to prevent damage or injury from equipment, etc, that can handle a certain voltage, frequency, or amperage, being plugged into a socket that provides electricity outside of those parameters. To accomplish this goal, IEC 60309 provides that plugs differ in their configurations to denote compatible voltage, frequency and amperage ranges and are color coded as such. For example, the diameter of the circular plug housing will designate amperage and the location of the ground pin in relation to the clocking tab, or plastic tab on the outside of the plug housing, denotes voltage and frequency range. The ground pin can be in one of 12 locations in reference to the clocking tab with each location varying by 30 degrees or one hour if the face of the plug is thought of as a clock face with the clocking tab at the 12 o'clock location. Pins of different types of plugs can also differ in diameter and length. For example, a three-phase plug to be used with 50 V at 300-500 Hz has a color coded green housing with the ground pin located at the 2 o'clock location or 60 degrees with varying plug housing diameters depending on the amperage.

While some of the power sockets found at marinas internationally may follow the IEC 60309 standard, many countries may have their own standard. Generally speaking, though, most three-phase sockets found at marinas internationally will most likely be a four (4) or five (5) pin terminal variety similar to IEC 60309 sockets having a ground terminal typically larger in diameter than the other terminals, with the neutral terminal (in the case of a five (5) pin socket) being immediately counterclockwise to the ground terminal followed by the L3, L2, and L1 phase terminals. Four (4) pin terminal sockets will not have a neutral terminal, but the order of the phase wire terminals will be the same.

While in practice it would be ideal for sockets at a marina to follow the IEC 60309 standard or another standard based upon the voltage, frequency and amperage of the shore power source, many times the type of socket installed is based upon what was available to the installer at the particular time the sockets were installed. Therefore, one could easily find a 50 V, 300-500 Hz green color coded socket with a ground terminal at 60 degrees having a socket housing with a radius designating 32 amps installed on a shore power source that provides 240 V at 60 Hz with 100 amps. Therefore, prior to connecting to a new shore power source, vessel engineers routinely check the voltage, amperage and frequency of shore power sockets to ensure compliance with their vessel's electrical system. While the inventor intends the invention to work primarily with vessels having power converters which have the ability to convert the voltage, frequency, and amperage of any available shore power electrical supply to the voltage, frequency, and amperage required by the vessel's power systems, the invention could also be used for vessel's without power converters as long as proper electrical standards and safety procedures are followed.

Though one may find one shore power socket configuration regularly used throughout a country or region, it is not uncommon for other socket configurations to also be used within that region. For example, there are known shore power socket configurations that are used in each of the following regions: United States, Europe, Middle East, North Africa, the Caribbean, and South East Asia. One could easily find one of these regional configurations or others being used in a different region.

Typically, a yacht or marine vessel has a marine power cable with a plug having a configuration compatible to the region where it is manufactured or where it is to be berthed. When the yacht or marine vessel moves to a marina that uses a different socket configuration from the plug currently installed on the vessel, the typical operating procedure for connecting the vessel to shore power is: (1) sourcing the correct plug for that particular location; (2) testing the power and determining the correct phase and wire location; (3) cutting and stripping the shore power cable/wire coming from the marine vessel; and (4) hard wiring the correct plug end to the existing bare wires. There are a number of problems with this procedure. First, sourcing the correct power plug for the location is sometimes very difficult and may take up to a week or longer, requiring the vessel to rely upon its generators for power. Generators are typically loud and therefore frowned upon being used in marinas because no one, including the vessel's owner or its marina neighbors, wants to hear the annoying hum of generators. Second, installing the newly sourced plug can be dangerous if it is wired incorrectly. Third, having to strip the Vessel's expensive power cable every time a new plug is installed shortens the power cable meaning it will eventually need to be replaced when it gets too short. Finally, having to disassemble the vessel's power cable plug every time it docks in a marina having a shore power socket with a different plug configuration creates wear and tear on the power plugs and on the vessel's power cable eventually resulting in one or both needing to be replaced.

In addition, it is not uncommon for marinas to have shore power sources which require the vessel to be hardwired to either a power terminal on the dock or hardwired to the end of a shore power cable which instead of having a socket installed has only bare wires. In these instances the standard operating procedure is to hard wire the vessel's shore power cable to the marine shore power source following a similar procedure as outlined above.

An alternative operating procedure would involve having multiple cable sets, each of which converts the type of plug configuration installed on the vessel to only one other configuration, thus requiring multiple sets of cables. Each cable set is very expensive and bulky, taking up prime storage space within the vessel. Even if a vessel is equipped with multiple sets of cables, sometimes a vessel will arrive at a marina that has a power plug configuration that is wholly different from any known configuration for which the vessel is equipped, thus requiring the installation of a new power plug following the procedure discussed above.

The present inventor herein has attempted to develop a third option that allows the vessel to be quickly and efficiently connected to shore power regardless of which dock-side power configuration is being used, whether known or unknown.

### BRIEF SUMMARY OF THE INVENTION

An object of the present invention is to provide a system for providing marine shore power that addresses the needs of supplying a vessel with high amperage three-phase electricity from a shore power source regardless of the configuration of a shore power source or the configuration of a socket installed on a shore power source. It is further an object of the present invention to provide a system for providing marine shore power to a vessel without the need to use multiple bulky and expensive cable sets or the need to rewire the vessel's power cable with a different plug each time the vessel docks in a marina where a different shore power source socket configuration is used.

It is an additional object of the invention to provide a system for providing marine shore power to a vessel that is easy to use, efficient and relatively inexpensive. Additionally still, it is an object of the present invention to provide a system for providing marine shore power which accepts a plurality of different adapters to connect a vessel to a shore power source by simply plugging an adapter, which is compatible to the socket used on the shore power source, into the vessel's shore power plug. Moreover, it is an object of the present invention to provide a system for connecting a marine shore power source, having a plug configuration presently unknown to the inventor, to a vessel by plugging in an adapter to the vessel's shore power plug which can accept installation of a power plug having the desired configuration.

To achieve the above-mentioned object, a system for providing marine shore is provided having a vessel plug which accepts a plurality of adapters that each has a variety of plug configurations. The vessel plug is intended to replace a vessel's shore power cable plug by installing it directly on the vessel's shore power cable. The vessel plug has a male plug component. Each of the plurality of adapters has a female socket component and a male adapter component. The male plug component of the vessel plug is compatible with and plugs into the female socket component of each of the adapters of the invention. The male adapter components are each configured differently so as to enable a vessel to connect to a shore power source regardless of the configuration of the shore power source or the configuration of any socket installed on the shore power source.

The majority of the adapters have configurations matching known four and five pin shore power socket configurations used internationally. These adapters enable a vessel, having the vessel plug of the invention installed on its shore power cable, to connect to any shore power source socket having one of these known configurations.

At least one or more of the adapters would also be provided which has the ability to connect directly to a three-phase shore power cable by installing the wires contained therein directly to the male adapter component of the adapter. Instead of the male adapter component having pins which insert into sockets of known configurations, the pins are hollow and can receive and secure the bare wires from a shore power cable. Being able to receive bare wires gives the adapter the versatility to attach to any shore power source regardless of the configuration of the shore power source or the configuration of a socket installed on a shore power source.

This versatility enables a vessel, having a vessel plug of the invention installed on its shore power cable, to connect to a shore power source in a number of circumstances: including when the shore power source has a cable with no socket installed; when a shore power source has no cable, but rather a power terminal into to which a vessel's shore power cable must be hardwired; and when the shore power source has a shore power source cable having a socket with an unknown configuration, of which, none of the previously mentioned adapters are compatible. In the first circumstance the bare wires of the shore power source cable can be installed into the adapter. In the second circumstance a shore power cable having a required length can be installed into the adapter with the other end hard wired to the shore power source terminal. In the latter circumstance, a vessel plug meeting the configuration of the unknown socket configuration can be sourced and installed on one end of a shore power cable and plugged into the shore power source socket, with the adapter being installed on the other end of the cable. In each of these circumstances the vessel plug of the invention installed on a vessel will plug in to the adapter and thereby provide the vessel with shore power.

From this point forward, the adapter, newly sourced vessel plug setup or the adapter cable setup can be saved used with the system just like any other adapter. It is the intention of the inventor to include two or more of adapter these types of adapters, as a vessel may come across more than one marina where a previously unknown shore power configuration is used or a socket with an unknown configuration is installed on the shore power source cable.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a front perspective view illustrating a vessel-side marine shore power plug 10 (hereinafter, simply “vessel plug”) ready to receive a marine shore power plug adapter (hereinafter simply “adapter”), according to an embodiment;

FIG. 2 is a front perspective view illustrating the male terminal of a vessel plug and the receiving female terminal of an adapter, according to an embodiment;

FIG. 3 is an exploded perspective view diagram illustrating a vessel plug, according to an embodiment;

FIG. 4 is a diagram illustrating a front side cross section view of a vessel plug;

FIG. 5 is an exploded perspective view diagram illustrating an adapter having a plug configuration that is a first variation of a plug regularly, but not exclusively, used in Europe, according to an embodiment;

FIG. 5A is a top plan view of an adapter having a plug configuration that is a first variation of a plug regularly, but not exclusively, used in Europe, according to an embodiment;

FIG. 5B is a top plan side view of an adapter having a plug configuration that is regularly, but not exclusively, used in the Middle East, Europe and South East Asia, according to an embodiment;

FIG. 5C is a top plan view of an adapter having a plug configuration that is regularly, but not exclusively, used in France and North Africa, according to an embodiment;

FIG. 5D is a top plan view of an adapter having a plug configuration that is regularly, but not exclusively, used in Europe, the Middle East, and the Caribbean, according to an embodiment;

FIG. 5E is a top plan view of an adapter having a plug configuration that is a second variation of a plug regularly, but not exclusively, used in Europe, according to an embodiment;

FIG. 5F is a top plan view of an adapter having a plug configuration that is regularly, but not exclusively, used in the United States, according to an embodiment;

FIG. 6 is an exploded perspective view of an adapter which can receive wire leads enabling the adapter to be attached to a shore power source regardless of the shore power source configuration or the configuration of any socket installed on the shore power source cable;

FIG. 6A is a top plan view of an adapter which can receive wire leads as shown in FIG. 6; and

FIG. 6B is a front perspective view of an adapter which can receive wire leads as shown in FIGS. 6 and 6A.

### INVENTION DESCRIPTION

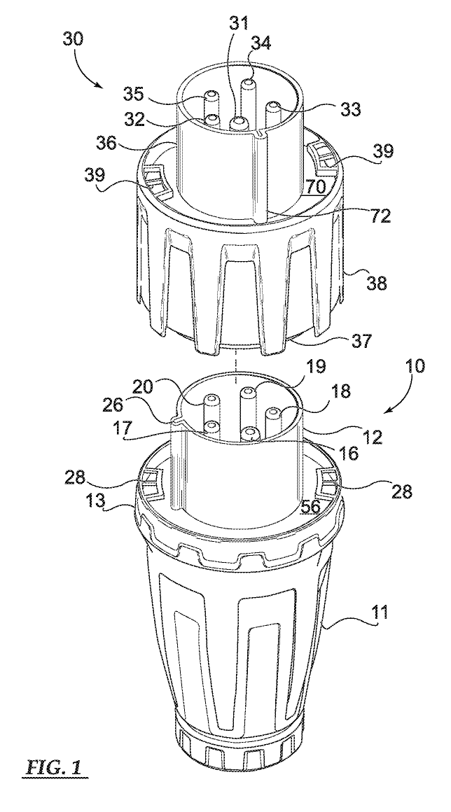

Initially with regards to FIG. 1, a first preferred embodiment of a system for providing marine shore power is shown. The system for providing marine shore power, as main elements, has a vessel-side marine shore power plug 10 (hereinafter, simply “vessel plug 10”) and a marine shore power plug adapter 30 (hereinafter, simply “adapter 30”). Vessel plug 10 is intended to be installed on a vessel's shore power cable replacing the vessel's shore power plug. Adapter 30 attaches to and is secured on vessel plug 10. Together, vessel plug 10 and adapter 30 and the other adapters disclosed herein enable a vessel's power system to connect to any shore power source regardless of the configuration of the shore power source or the configuration of any socket that may be installed on the shore power source. Unless otherwise stated, the majority of the components of vessel plug 10 in this embodiment are made from injection molded glass filled polypropylene, polymer or copolymer plastic which is flame retardant, heat resistant, non-conductive and has good impact resistance, tensile strength and toughness. The exterior components may also have a rubber coating for an easier grip. Other embodiments may use similar materials known in the art having similar qualities.

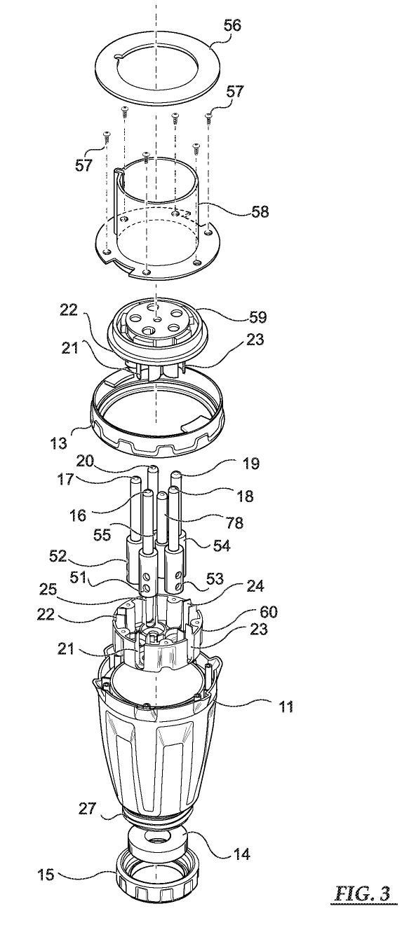

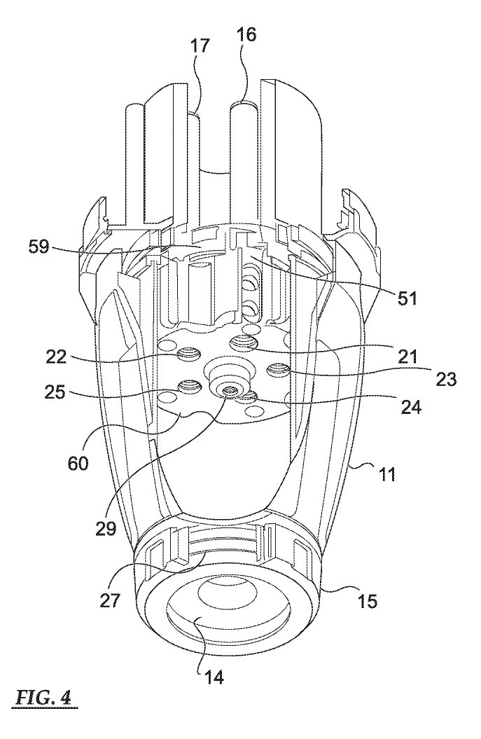

With reference to FIG. 1, a lock ring 13, having locking tabs 28, is attached to a housing 11. Lock ring 13 can freely rotate about the center axis of housing 11. When adapter 30 and vessel plug 10 are attached, lock ring 13 with locking tabs 28 secures adapter 30 to vessel plug 10. A terminal block 12 is also attached to housing 11. Terminal block 12 has a top portion and a bottom portion with only the top portion being shown in FIG. 1. The bottom portion of terminal block 12 is enclosed within housing 11 which is shown in FIGS. 3 and 4.

Further with regards to FIG. 1, the top portion of terminal block 12 comprises a circular plug housing having a flange extending circumferential from its bottom outer surface. The circular plug housing also has an alignment tab 26 which extends axially from its outer surface. The circular plug housing encloses each of a first end piece of a ground pin 16, a neutral pin 17, an L1 phase pin 18, an L2 phase pin 19, and an L3 phase pin 20 (hereinafter simply “pins 16, 17, 18, 19, and 20”). A pilot contact 78 (not shown), has a first end in the center of the male plug component for safely grounding vessel plug 10 when first inserted into adapter 30 or other adapters. The circular plug housing, pins 16 through 20, and pilot contact 78, together, make up a male plug component of vessel plug 10. A second end piece of each of pins 16 through 20 is enclosed in the bottom portion of the terminal block, which is shown in FIGS. 3 and 4. In this embodiment, Pins 16 through 20 are comprised of stainless steel which is highly conductive and has non-corrosive properties to prevent them from rusting in a salt water marine environment. In other embodiments pins 16 through 20, could be made out of similar materials known in the art having similar conductive and non-corrosive properties.

Additionally with regards to FIG. 1, a gasket 56 is shown encircling the top portion of terminal block 12 and sitting on top of the circular plug housing flange. In this embodiment gasket 56 is comprised of silicone or similar material known in the art which is non-conductive and can endure the heat produced by the electricity from a high amperage shore power source going through vessel plug 10 while in use. When adapter 30, or another embodiment of adapter 30, is attached and secured to vessel plug 10, gasket 56 is compressed between the circular plug housing flange and adapter 30, thereby creating a water proof seal, preventing moisture from entering housing 11 where terminal block 12 attached thereto or entering through the bottom of adapter 30. Other embodiments may employ a similar means known in the art to water proof vessel plug 10 and adapter 30.

In other embodiments, vessel plug 10 may also incorporate additional features of electrical connectors known in the art. Also, in other embodiments vessel plug 10 could have plug configurations that vary with respect to: diameter of the circular plug housing, depth of plug housing, location of ground pin in reference to the clocking tab, pin size and length, number and location of pins, use of pilot contact, and amperage, voltage, and frequency specifications to match marine shore power sockets having known or unknown configurations without the use of an adapter. In these alternative embodiments the sockets of adapters would match the plug configuration of vessel plug 10 to allow a vessel to connect to shore power supplies having sockets with a variety of configurations.

Further with regards to FIG. 1, adapter 30 is shown. Adapter 30 has a plug configuration matching a socket configuration that is a first variation of a plug regularly, but not exclusively, used in Europe (“European Socket-V1”). Unless otherwise stated, the majority of the components of adapter 30 in this embodiment, like those of vessel plug 10, are made from injection molded glass filled polypropylene, polymer or copolymer plastic which is flame retardant, heat resistant, non-conductive and has good impact resistance, tensile strength and toughness. The exterior components may also have a rubber coating for an easier grip. Other embodiments of the invention may use other materials known in the art having similar qualities. An adapter lock ring 38, having locking tabs 39, is shown attached to and mostly enclosing an adapter terminal block 37 and minimally enclosing an adapter housing 36. Lock ring 38 can freely rotate about the center axes of adapter terminal block 37 and adapter housing 36.

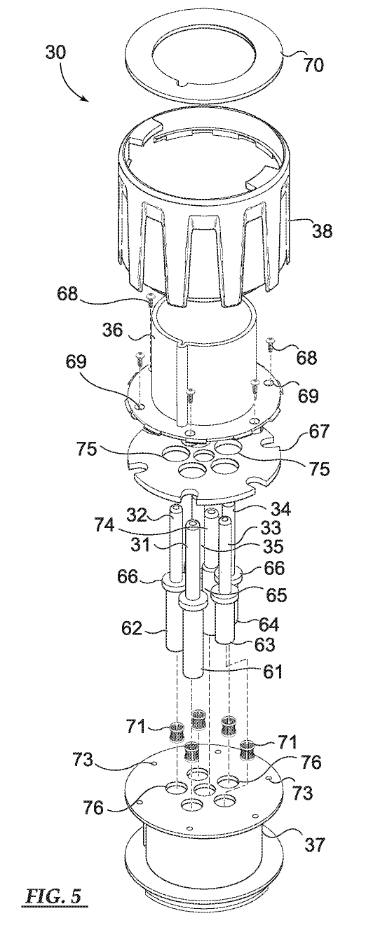

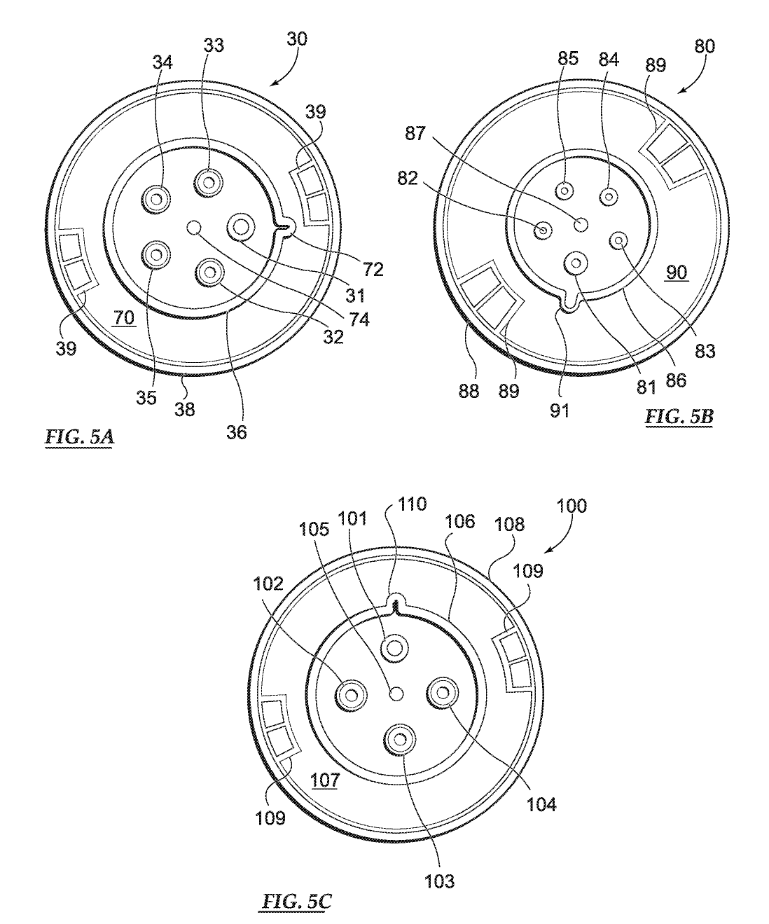

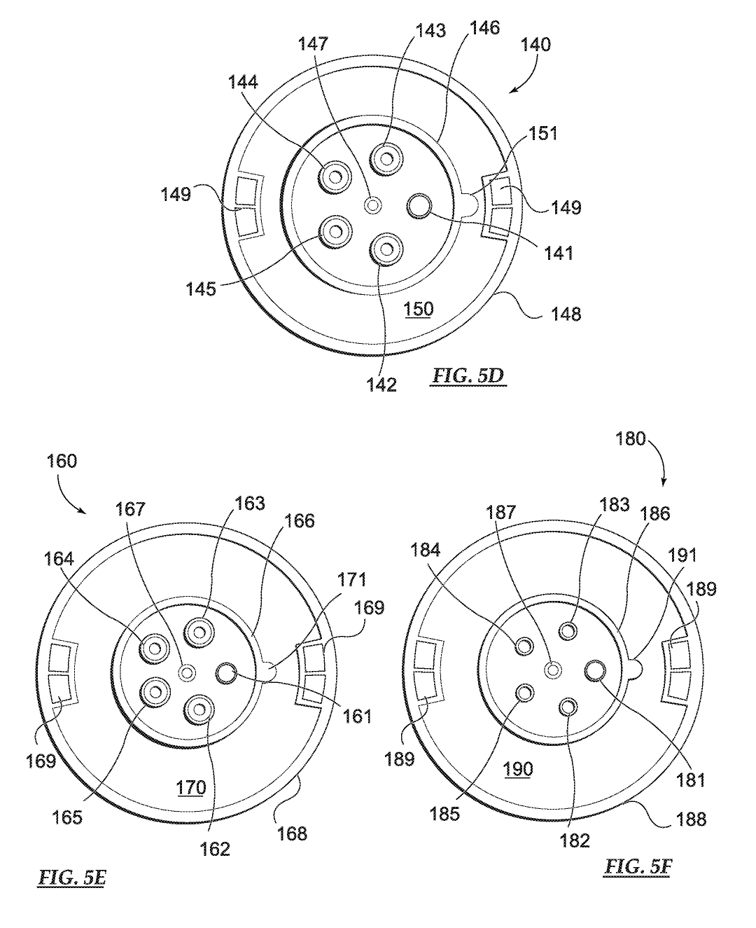

Adapter 30 is additionally comprised of an adapter ground pin 31, an adapter neutral pin 32, an adapter L1 phase pin 33, an adapter L2 phase pin 34, and an adapter L3 phase pin 35 (hereinafter, simply “adapter pins 31, 32, 33, 34, and 35”). In this embodiment, Pins 31 through 35 are comprised of stainless steel which is highly conductive and has non-corrosive properties to prevent them from rusting in a salt water marine environment. In other embodiments of the invention, pins 31 through 35 could be made out of similar materials known in the art having similar conductive and non-corrosive properties. Adapter pins 31 through 35 each have a first end portion which is enclosed by adapter housing 36. Together, with adapter housing 36, the first end portions of adapter pins 31 through 35 make up a male adapter component of adapter 30. An adapter pilot contact 74, not shown, has a first end located in the center of the male adapter component for safely grounding adapter 30 when plugged into a vessel shore power source socket. Adapter pins 31 through 35 each further have 61 through 65, shown in FIG. 5, having hollow cavities to receive the first end piece of respective pins 16 though 20, creating an electrical connection between each second end portion and the respective first end piece. Each of the second end portions 61 through 65, of adapter pins 31 through 35, are enclosed within adapter terminal block 37, with the ends of each second end portion protruding into cylindrical recesses in the bottom of adapter terminal block 37. Adapter pins 31 through 35 each have first end portions and second end portions having axes which are aligned. However, adapters having male adapter components with configurations differing from the configuration of adapter 30 may have pins with first end portions having axes which are offset from the axes of their second end portions.

Further with regards to the embodiment shown in FIG. 1, adapter housing 36 has a clocking tab 72 extending axially from its outer surface. In addition, adapter housing 36 has a flange extending circumferential from its bottom outer surface on which a gasket 70 sits. In this embodiment, gasket 70 is comprised of silicone or a similar material known in the art which is non-conductive and can endure the heat produced by the electricity from a high amperage shore power source going through adapter 30 while in use. To connect adapter 30 to the European Socket-V1, the male adapter component is inserted into the European Socket-V1. Tightening lock ring 38 results in locking tabs 39 engaging and pulling corresponding lock plates on the European Socket-V1 axially in the direction of adapter 30. When adapter 30 is attached to the European Socket-V1, gasket 70 is compressed between the flange of adapter housing 36 and the shore power source socket, thereby creating a water proof seal, keeping moisture out of adapter 30 and away from adapter pins 31 through 35 or the corresponding terminals of the shore power source socket. Other embodiments may employ other means known in the art to water proof adapter 30.

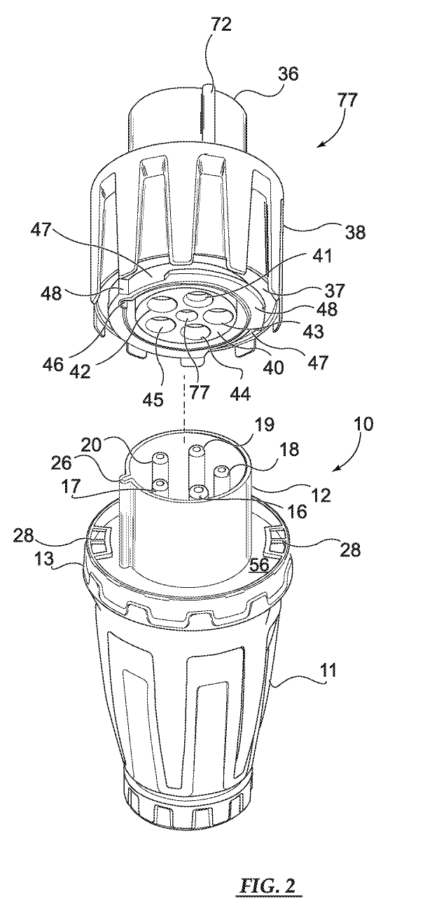

Initially with regards to FIG. 2, a bottom perspective view of adapter 30 and its components is shown. The bottom of adapter terminal block 37 is shown to have an adapter socket 40 surrounded by a circular recess having an alignment channel 46. Adapter socket 40 and alignment channel 46 receive the circular plug housing of terminal block 12 and alignment tab 26. Adapter socket 40 also has an adapter ground terminal 41, an adapter neutral terminal 42, an L1 adapter phase terminal 43, an L2 adapter phase terminal 44, and an L3 adapter phase terminal 45 (hereinafter, simply “adapter terminals 41, 42, 45, 44, and 45”). Adapter terminals 41 through 45 are the previously discussed cylindrical recesses in the bottom of adapter terminal block 37 into which the ends of the second end portions 61 through 65, of adapter pins 31 through 35, protrude. Adapter terminals 41 through 45 and second end portions 61 through 65, of adapter pins 31 through 35, receive pins 16 through 20 when adapter 30 is attached to vessel plug 10. A n adapter pilot contact 74 (shown in FIGS. 5 and 5A) has a second end enclosed within a terminal 77 which receives pilot contact 78 (shown in FIG. 3) of vessel plug 10 and which safely grounds adapter 30 to vessel plug 10 while connecting thereto.

Further with regards to FIG. 2, lock plates 48, diametrically opposite to each other, extend semi-circumferentially and perpendicularly from the outer surface of terminal block 37 nearest the bottom of terminal block 37. Each lock plate 48 has a first end and a second end, which are diametrically opposite from the respective first end and second end of other lock plate 48. Each lock plate 48 has a ramp increasing clockwise in height from its first end to its second end. Abutting the second end of each lock plate 48 is a tab having a vertical height approximately twice the vertical height of the second end of each lock plate 48. Each tab which extends radially from the outer surface of the adapter terminal block so that the outer radial surface of each tab is flush with the outer radial surface of each lock plate 48. Notches 47 are shown as the arc spaces along the outer surface of terminal block 37 between the first end of each lock plate 48 and the tab abutting the second end of the other lock plate 48.

To insert the male plug component of vessel plug 10 into adapter socket 30, insert the circular plug housing of terminal block 12 into the circular recess of socket 40, while simultaneously aligning alignment tab 26 with alignment channel 46 and locking tabs 28 with notches 47. Doing so will result in pins 16 through 20 inserting into adapter terminals 41 through 45 and into the second end portions 61 through 65 of pins 31 through 35. To secure adapter 30 onto vessel plug 10, press adapter 30 onto vessel plug 10 and rotate lock ring 13 so that the bottom surface of each locking tab 28 slides along the top surface of each lock plate 48 from its first end to its second end until each locking tab 28 is stopped by the tab abutting the second end of each lock plate 48. Rotating lock ring 13 pulls adapter 30 towards vessel 10 fully seating adapter 30 onto vessel plug 10. Attaching adapter 30 to vessel plug 10 and locking with lock ring 13 creates electrical connections between pins 16 through 20 of vessel plug 10 and respective terminals 41 through 45 of adapter 30. Other ways known in the art to attach and secure adapter 30 to vessel plug 10 could be used in other embodiments. Once adapter 30 is secured to vessel plug 10, the vessel's shore power cable can be connected to a marine shore power supply by inserting the male adapter component of adapter 30 into a compatible shore power socket, thus providing the vessel with electrical power.

In this embodiment, other adapters, vary with respect to: the diameter, thickness and depth of adapter housing 36; diameter, length, location and number of adapter pins; use of a neutral adapter pin; location of ground pin 31 in relation to clocking tab 72; use of a pilot contact; number of phases; and amperage, voltage, and frequency specifications to match marine shore power sockets having known configurations. These other adapters could have configurations compatible with sockets having configurations regularly used in Europe, the Middle East, North Africa, the Caribbean, or South East Asia; sockets with configurations based upon national, regional, or international standards; and sockets with other configurations. These other plugs would allow a vessel's shore power cable to be connected to a variety of shore power source sockets all having different configurations. See FIGS. 5A through 5F for examples of adapters with configurations which vary from the configuration of adapter 30.

Initially with regards to FIG. 3, an exploded perspective view of vessel plug 10 of the first preferred embodiment is shown. Terminal block 12 shown in FIGS. 1 and 2 is shown here as three separate components: circular plug housing 58; receptacle 59; and wiring cover 60. Pins 16 through 20 and a pilot contact 78 are enclosed within terminal block 12. In other embodiments terminal block 12 may be comprised of one or more separate components. The second end pieces of pins 16 through 20 are shown as respective terminals 51, 52, 52, 54, and 55. In this embodiment, terminals 51 through 55 are hollow in order to receive wires from a vessel's shore power cable. Terminals 51 through 55 also have a means for holding the vessel's shore power cable wires in place, which in this embodiment are two threaded holes perpendicular to the length of each pin that receive set screws. When seated, the set screws pinch the wires against the inside radial surface of the pins' terminals creating an electrical connection. In other embodiments, different means known in the art could be used to hold the vessel power cable wires in place and/or to create the electrical connections.

Terminals 51 through 55 are each enclosed within a respective terminal 21, 22, 23, 24, and 25 created by joining the bottom of receptacle 59 and the top of wiring cover 60. When terminal block 12 is fully assembled, with pins 16 through 20 enclosed therein, the hollow cavitis of terminals 51 through 55 are accessible through holes in the bottom of wiring cover 60, with the set screws of being accessible through the sides of terminals 21 through 25.

Further with regards to FIG. 3, the bottom portion of terminal block 12, consisting of wiring cover 60, receptacle 59, and enclosed terminals 51 through 55, inserts into housing 11. The circumferential flange of circular plug housing 58 has a plurality of holes through which screws 57 secure terminal block 12 to housing 11. Gasket 56 sits on top of the circumferential flange of circular plug housing 58, covers the screws 57, and is compressed when vessel plug 10 is inserted into and secured to adapter 30 or another adapter, creating a waterproof seal over screws 57 and around circular plug housing 58. Additionally with regards to FIG. 3, housing 11 has a receiving end 27 having an internally recessed bevel which creates a cylindrical pocket to receive a smash seal 14. Receiving end 27 has threading to receive a compression nut 15 having complementary threading thereto. Threading compression nut 15 onto receiving end 27, with smash seal 14 seated within the cylindrical pocket and a vessel shore power cable installed, compresses smash seal 14 into the cylindrical pocket and around the vessel's shore power cable creating waterproof seals keeping water and moisture from penetrating housing 11 through receiving end 27. Other embodiments of the invention could use one or more of the various other forms of waterproofing known in the art to ensure vessel plug 10 is waterproof or water resistant.

FIG. 4 is an internal view illustrating the bottom portion of terminal block 12 (receptacle 59 and wiring cover 60) inserted into housing 11, with the top portion of terminal block 12 (circular plug housing 58) secured to housing 11. More specifically FIG. 4 illustrates the second end pieces of pins 16 through 20 (terminals 51 through 55) enclosed within respective terminals 21 through 25 of terminal block 12. The set screws and hollow cavities of terminals 51 through 55, as described above, are visible by example in terminal 51, which when utilized receive and secure a vessel's shore power cable wires. Additionally, compression nut 15 is shown threaded onto receiving end 27, which compresses smash seal 14 into the cylindrical pocket of receiving end 27. A pilot contact terminal 29 is shown in the center of wiring cover 60 and encloses a second end piece of pilot contact 78. Pilot contact terminal 29 has a means for receiving and securing a ground wire for safely grounding vessel plug 10, when first inserted into adapter 30 or another adapter.

Initially with regards to FIG. 5, an exploded perspective view of adapter plug 30 of the first preferred embodiment is shown. The hollow cavities of second end portions 61 through 65 of adapter pins 31 through 35, receive spring contacts 71. When the first end pieces of pins 16 through 20 are inserted into second end portions 61 through 65, spring contacts 71 compress, pushing axially against the inside circular surface of each second end portion and the end surfaces of the first end pieces of pins 16 through 20, creating an electrical connection therebetween. Adapter pins 31 through 35 have shoulders 66 separating their first and second end portions. The second end of pilot contact 74 and second end pieces 61 through 65, with inserted spring contacts 71, are received by adapter terminal block 37. An adapter pin plate 67 has shoulder holes 75 which receive shoulders 66 and the second end of pilot contact 74. Adapter pin plate 67 sits on top of adapter terminal block 37. Adapter housing 36 sits on top of adapter pin plate 67, enclosing the first end pieces of adapter pins 31 through 35 and the first end of pilot contact 74. Screws 68 are shown, which are received by holes 69 in adapter housing 36 and received by threaded holes 73 in adapter terminal block 37. Inserting screws 68 through adapter housing 36 and adapter pin plate 67 and tightening into holes 73 secures adapter housing 36 and adapter pin plate 67 to adapter terminal block 37, enclosing the first ends of adapter pins 31 through 35 within adapter housing 36 and securing second end portions 61 through 65 and the second end of pilot contact 74 within adapter terminal block 37. Gasket 70 sits on top of screws 69 and holes 68 and is compressed when adapter 30 is inserted into and secured to a shore power source socket, creating a waterproof seal over screws 69, holes 68 and around housing 36. Lock ring 38 is attaches to and mostly encloses adapter terminal block 37 and minimally encloses adapter housing 36. Lock ring 38 can freely rotate about the center axes of adapter terminal block 37 and adapter housing 36.

FIG. 5A depicts a top plan view of adapter 30. FIG. 5 shows adapter pilot contact 74 in the center of the male adapter component of adapter 30. Attaching adapter 30 to vessel plug 10 allows a vessel's shore power cable to be connected to a shore power source using a socket configuration that is a first variation of a plug regularly, but not exclusively, used in Europe (“European Socket-V1”)

Adapters 80, 100, 140, 160, and 180, as shown in FIGS. 5B through 5F below, are adapters having alternative configurations to adapter 30 and are primarily comprised of the same components as adapter 30. The alternative configurations of adapters 80, 100, 120, 140, 160, and 180 are specifically designed to match marine shore power source sockets having specific configurations. Each of these adapter configurations may vary with respect to: the diameter, thickness and depth of adapter housing; location, size, length, diameter and number of adapter pins; use or nonuse of an adapter neutral pin; and location of the adapter ground pin in relation to the clocking tab. In other embodiments, alternative adapter configurations could also vary with respect to: whether an adapter pilot contact is used; number of phases; and amperage, voltage, and frequency specifications.

FIG. 5B depicts a top plan view of a marine shore power adapter 80, which has an alternative male adapter component configuration to that of adapter 30. Adapter 80 has a plug configuration matching a shore power source socket configuration that is regularly, but not exclusively, used in the Middle East, Europe and South East Asia. Attaching adapter 80 to vessel plug 10 allows a vessel's shore power cable to be connected to a shore power source using a socket compatible thereto. Adapter 80 comprises an adapter ground pin 81, an adapter neutral pin 82, an L1 adapter phase pin 83, an L2 adapter phase pin 84, an L3 adapter phase pin 85, and a pilot contact 87. Adapter 80 further comprises an adapter housing 86 having a clocking tab 91, a gasket 90, and a lock ring 88 having locking tabs 89.

FIG. 5C depicts a top plan view of a marine shore power adapter 100 which has an alternative male adapter component configuration to that of adapter 30. Adapter 100 has a plug configuration matching a shore power source socket configuration that is regularly, but not exclusively, used in the France and North Africa. Attaching adapter 100 to vessel plug 10 allows a vessel's shore power cable to be connected to a shore power source using a socket compatible thereto. Adapter 100 is comprised of an adapter ground pin 101, an L1 adapter phase pin 102, an L2 adapter phase pin 103, an L3 adapter phase pin 104, and a pilot contact 105. Adapter 100 further comprises an adapter housing 106 having a clocking tab 110, a gasket 107, and a lock ring 109 having locking tabs 109. Adapter 100 does not have an adapter neutral pin as the shore power source socket it configured to be compatible with does not use a neutral terminal.

FIG. 5D depicts a top plan view of a marine shore power adapter 140 which is an alternative embodiment of adapter 30. Adapter 140 has a plug configuration matching a socket configuration that is regularly, but not exclusively, used in Europe, the Middle East, and the Caribbean. Attaching adapter 140 to vessel plug 10 allows a vessel's shore power cable to be connected to a shore power source using a socket compatible thereto. Adapter 140 comprises an adapter ground pin 141, an adapter neutral pin 142, an L1 adapter phase pin 143, an L2 adapter phase pin 144, an L3 adapter phase pin 145, and a pilot contact 147. Adapter 140 further comprises an adapter housing 146 having a clocking tab 151, a gasket 150, and a lock ring 148 having locking tabs 149.

FIG. 5E depicts a top plan view of a marine shore power adapter 160 which is an alternative embodiment of adapter 30. Adapter 160 has a plug configuration matching a socket having a configuration that is a second variation of plug regularly, but not exclusively, used in Europe. Attaching adapter 160 to vessel plug 10 allows a vessel's shore power cable to be connected to a shore power source using a socket compatible thereto. Adapter 160 comprises an adapter ground pin 161, an adapter neutral pin 162, an L1 adapter phase pin 163, an L2 adapter phase pin 164, an L3 adapter phase pin 165, and a pilot contact 167. Adapter 160 further comprises an adapter housing 166 having a clocking tab 171, a gasket 170, and a lock ring 168 having locking tabs 169.

FIG. 5F depicts a top plan view of a marine shore power adapter 180 which is an alternative embodiment of adapter 30. Adapter 180 has a pin configuration matching a socket having a configuration that is regularly, but not exclusively, used in the United States. Attaching adapter 180 to vessel plug 10 allows a vessel's shore power cable to be connected to a shore power source using a socket compatible thereto. Adapter 180 comprises an adapter ground pin 181, an adapter neutral pin 182, an L1 adapter phase pin 183, an L2 adapter phase pin 184, an L3 adapter phase pin 185, and a pilot contact 187. Adapter 180 further comprises an adapter housing 186 having a clocking tab 191, a gasket 190, and a lock ring 188 having locking tabs 189.

In other embodiments, alternative adapters may be included having male adapter component configurations that vary with respect to: the diameter, thickness and depth of adapter housing; location, size, length, diameter and number of adapter pins; use or nonuse of an adapter neutral pin; and location of the adapter ground pin in relation to the clocking tab. They could also vary with respect to: whether an adapter pilot contact is used; number of phases; and amperage, voltage, and frequency specifications.

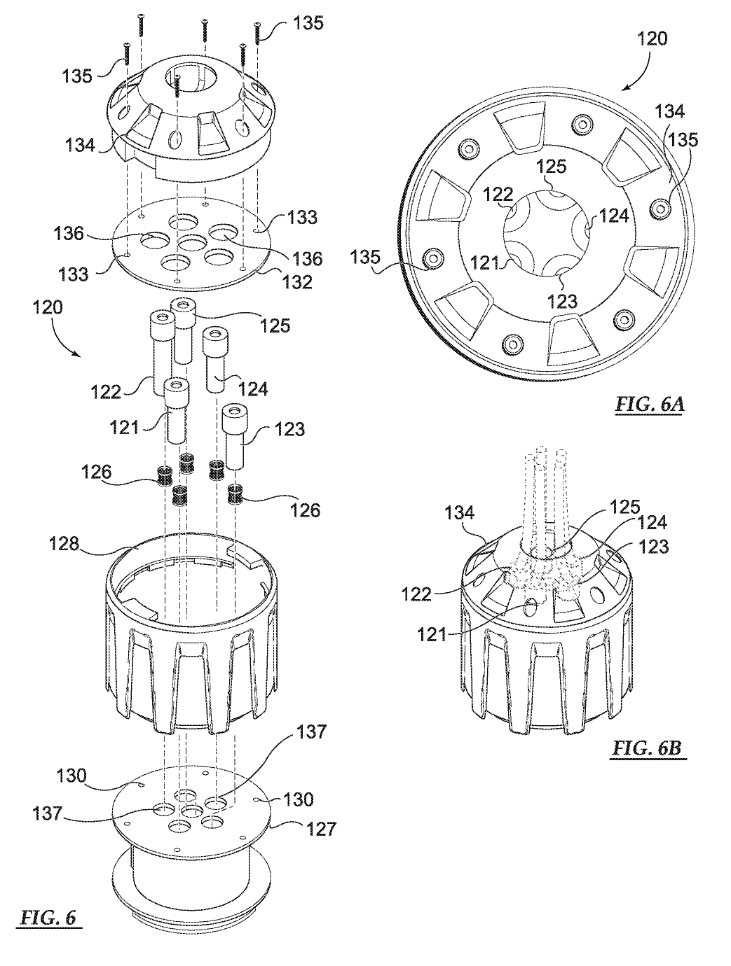

FIG. 6 depicts an adapter 120. Adapter 120 is meant to be installed on vessel plug 10 in those instances when a vessel docks at a marina where none of the previously mentioned adapters will match the socket available to the vessel. As such, adapter 120 does not have pins designed to be compatible with a shore power socket having a specific configuration. Rather, adapter 120 has an adapter ground pin 121, an adapter neutral pin 122, an L1 adapter phase pin 123, an L2 adapter phase pin 124, and an L3 adapter phase pin 125 (hereinafter, “adapter pins 121 through 125”) having first end portions with each having a cavity to receive and secure the respective ground, neutral, and L1, L2, and L3 phase wire from a three-phase electrical cable, creating an electrical connection between each first end portion and the respective wire. In this embodiment, wires can be secured within adapter pins 125 through 125 with solder. In other embodiments, other means known in the art would be used to secure the wires within adapter pins 121 through 125.

Further with regards to FIG. 6, the second end portions of adapter pins 121 through 125 are just like adapter pins 31 through 35 having hollow cavities to receive the first end pieces of pins 16 through 20. Here, spring contacts 126 insert into the second end portions of adapter pins 121 through 125 and when followed by the insertion of pins 16 through 20, creating an electrical connection therebetween. The second end portions of adapter pins 121 through 125 insert into adapter terminal block 127. An adapter pin plate 132 has holes 136 which receive the first end portions of adapter pins 121 through 125. Adapter pin plate 132 sits on top of adapter terminal block 127 enclosing the second end portions of pins 121 through 125 within adapter terminal block 127. Adapter 134 sits on top of adapter pin plate 132 enclosing the first end portions of pins 121 through 125 therein. Screws 135 are shown, which are received by holes in adapter cover 134, holes 133 in adapter pin plate 132 and threaded holes 130 in adapter terminal block 127. Inserting screws 135 through adapter cover 134 and adapter pin plate 132 and tightening them into holes 130 secures adapter cover 134 and adapter pin plate 132 to adapter terminal block 127, enclosing the first ends of adapter pins 121 through 125 within adapter cover 134 and securing second end portions of adapter pins 121 through 125 within adapter terminal block 127. Lock ring 128 is attaches to and mostly encloses adapter terminal block 127. Lock ring 28 can freely rotate about the center axis of adapter terminal block 127.

FIG. 6A shows a top plan view of adapter 120. Screws 135 are shown securing adapter cover 134 to adapter terminal block 127, with adapter 134 enclosing the first end portions of adapter pins 121 through 125.

FIG. 6B shows a front perspective view of adapter 120, illustrating how what adapter 120 would look like with three-phase electrical cables installed within adapter 120. The wires are shown inserted through a center hole of adapter cover 134 and into adapter pins 121 through 125.

Adapter 120 can be used in instances when a shore power source cable having no socket installed by installing adapter 120 directly onto the bare wires of the shore power source cable. Adapter 120 can additionally be used in instances where a shore power cable source socket has a configuration that isn't compatible with any of the adapters 80, 100, 140, 160, or 180. In such an instance, a vessel plug that is compatible with the shore power source socket configuration can be sourced and connected to adapter 120 through the use of a section of cable connected to adapter 120 and the newly sourced vessel plug. Lastly, adapter 120 can be connected to a shore power source in instances where only a shore power source terminal is provided without a cable. In such an instance a section of cable can be connected to adapter 120, with the other end of the section of cable connected to the shore power source terminal.

From this point forward: the adapter 120, newly sourced vessel plug setup; or the setup adapter 120 and cable setup can be used with the system just like any other adapter. It is the intention of the inventor for the System for Providing Marine Shore Power to include two or more of adapter 120 as a vessel may come across more than one marina where a previously unknown shore power configuration is used or a socket with an unknown configuration is installed on the shore power source cable.

The ability to install adapter 120 to any three-phase power cable, gives adapter 120, used with vessel plug 10, the versatility to attach to any shore power source regardless of the shore power source configuration or the configuration of a socket installed on a shore power source. Once wires from a three-phase electrical cable are installed into adapter 120 and with adapter 120 fully assembled, electrical potting resin, silicone sealant or another similar material known in the art can be used to waterproof adapter 120.

While the particular System for Providing Marine Shore Power as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims (to be added upon conversion).

What is claimed:

1. A system for providing marine shore power comprising:
a vessel plug comprising:
a male plug component; and
a cable housing component;
a plurality of adapters, each comprising:
a female socket component; and
a male adapter component;
wherein the cable housing component of the vessel-side shore power plug receives and installs on a vessel shore power cable;
wherein the female socket component of each of the plurality of adapters interchangeably attaches to the male plug component of the vessel plug, creating an electrical connection therebetween;
wherein the each of the male adapter components are each configured differently to attach to, are compatible with and attach to shore power sources with sockets having known configurations or are otherwise uniquely configured to attach or connect to any shore power source regardless of the configuration of the shore power source, creating an electrical connection between each male adapter component and the shore power source;
wherein each of the male adapter components has a configuration unique from each other male adapter component so that regardless of the particular configuration of a shore power source or the particular configuration of a socket that may be installed on a shore power source, at least one of the male adapter components is compatible with and attaches to the socket installed on the shore power source or otherwise connects to the shore power source regardless of the configuration thereof, creating an electrical connection between the attached male adapter component and the shore power source;
wherein installing the vessel-side shore power plug on a vessel shore power cable, attaching or connecting a compatible male adapter component of an adapter to a shore power source, and attaching the installed vessel-side shore power plug to the attached or connected compatible male adapter component of an adapter creates an electrical connection between the vessel's shore power cable and the shore power source and provides electricity to the vessel from the shore power source provided the shore power source outputs electrical power;
wherein the vessel plug and the plurality of adapters have means to safely ground the vessel plug and the plurality of adapters to a shore power source; and
wherein the vessel-side shore power plug and the plurality of adapters are configured to provide three-phase electrical power to a marine vessel, up to, including, and exceeding 100 amperes of current, regardless of the configuration of the shore power source or the configuration of any socket that may be installed on the shore power source.

2. The system for providing marine shore power of claim 1, wherein the vessel plug further comprises:
a ground pin, a neutral pin, an L1 phase pin, an L2 phase pin, and an L3 phase pin, with each comprising a first end piece and a second end piece;
a terminal block comprising a top portion and a bottom portion;
a smash seal;
a compression nut;
a lock ring having a means to secure each of the plurality of adapters to the vessel plug; and
a housing comprising a first end and a second end;
wherein the male plug component is comprised of the top portion of the terminal block and the first end pieces of the ground pin, neutral pin, L1 phase pin, L2 phase pin, and L3 phase pin;
wherein the cable housing component is comprised of the smash seal, the compression nut, the bottom portion of the terminal block, and the second end pieces of the ground pin, neutral pin, L1 phase pin, L2 phase pin, and L3 phase pin;
wherein the second end pieces of the ground pin, neutral pin, L1 phase pin, L2 phase pin, and L3 phase pin are each hollow and have a means to receive and secure at least one wire of a large gauge wire or smaller, such as one found within a vessel's shore power cable, creating an electrical connection between the wire and the respective pin;
wherein the top portion of the terminal block is comprised of a circular plug housing having a flange extending perpendicularly and circumferentially from the outer surface of the circular plug housing nearest the bottom portion of the terminal block;
wherein the first end pieces of the ground pin, neutral pin, L1 phase pin, L2 phase pin, and L3 phase pin are enclosed within the circular plug housing of the top portion of the terminal block;
wherein the bottom portion of the terminal block is comprised of a ground terminal, neutral terminal, an L1 phase terminal, an L2 phase terminal, and an L3 phase terminal, each of which encloses and secures the second end piece of the respective ground pin, neutral pin, L1 phase pin, L2 phase pin, and L3 phase pin;
wherein the first end of the housing has an opening to receive the bottom portion of the terminal block;
wherein the housing and the terminal block has a means to secure the terminal block to the housing;
wherein the second end of the housing has an internally recessed bevel creating a cylindrical pocket to receive the smash seal; and
wherein further the second end of the housing and the compression nut have complimentary threading allowing the compression nut to be threaded onto the second end of the housing.

3. The system for providing marine shore power of claim 1, wherein each of the plurality of adapters further comprises:
an adapter ground, an adapter neutral, an L1 adapter phase pin, an L2 adapter phase pin, and an L3 adapter phase pin, each comprising a first end portion and a second end portion;
an adapter terminal block comprising a first end and a second end;
an adapter housing comprising a first end and a second end; and
an adapter lock ring having a means to secure the adapter to a shore power source socket;
wherein the female socket component is comprised of the adapter terminal block and the second end portions of the adapter ground, adapter neutral, L1 adapter phase pin, L2 adapter phase pin, and L3 adapter phase pin;
wherein the male adapter component is comprised of the adapter housing, the adapter lock ring, and the first end portions of the adapter ground pin, adapter neutral pin, L1 adapter phase pin, L2 adapter phase pin, and L3 adapter phase pin;
wherein each of the second end portions of the adapter ground pin, adapter neutral pin, L1 adapter phase pin, L2 adapter phase pin, and L3 adapter phase pin has a cavity to receive the first end piece of the respective ground pin, neutral pin, L1 phase pin, L2 phase pin, and L3 phase pin, creating an electrical connection between each second end portion and the respective first end piece;
wherein the adapter terminal block is further comprised of an adapter ground terminal, an adapter neutral terminal, an L1 adapter phase terminal, an L2 adapter phase terminal, and an L3 adapter phase terminal, each of which extends axially through the adapter terminal block from its first end to its second end; wherein each of the second end portions of the adapter ground pin, adapter neutral pin, L1 adapter phase pin, L2 adapter phase pin, and L3 adapter phase pin is enclosed within the respective adapter ground terminal, adapter neutral terminal, L1 adapter phase terminal, L2 adapter phase terminal, and L3 adapter phase terminal;
wherein the first end portions of the adapter ground pin, adapter neutral pin, L1 adapter phase pin, L2 adapter phase pin, and L3 adapter phase pin protrude from the first end of the adapter terminal block;
wherein the second end of the adapter terminal block is comprised of a circular recess having an alignment channel;
wherein the second end of the adapter housing has a flange which extends perpendicular to and circumferentially around the second end of the adapter housing; and
wherein the second end of the adapter housing attaches to the first end of the adapter terminal enclosing the first end portions of the adapter ground pin, adapter neutral pin, L1 adapter phase pin, L2 adapter phase pin, and L3 adapter phase pin within the adapter housing.

4. The system for providing marine shore power of claim 3, wherein one or more of the plurality of adapters have a male adapter component comprised of the first end portions of the adapter ground pin, L1 adapter phase pin, L2 adapter phase pin, and L3 adapter phase pin, the adapter housing, and the adapter lock ring; and
wherein the male adapter component attaches to a shore power source with an installed socket having only four pin terminals, one for each adapter ground pin, L1 adapter phase pin, L2 adapter phase pin, and L3 adapter phase pin.

5. The system for providing marine shore power of claim 3, wherein one or more of the plurality of adapters have a male adapter component comprised of an adapter cover and the first end portions of the adapter ground pin, adapter neutral pin, L1 adapter phase pin, L2 adapter phase pin, and L3 adapter phase pin;
wherein each of the first end portions of the adapter ground pin, adapter neutral pin, L1 adapter phase pin, L2 adapter phase pin, and L3 adapter phase pin has means to receive and secure respective ground, neutral, and L1, L2, and L3 phase wires from a three-phase electrical cable, creating an electrical connection between each first end portion and the respective wire;
wherein the means to receive and secure respective ground, neutral, and L1, L2, and L3 phase wires from a three-phase electrical cable enables a vessel having the vessel plug installed on its shore power cable to connect its power system to a shore power source having a shore power supply cable with no socket installed;
wherein the means to receive and secure respective ground, neutral, and L1, L2, and L3 phase wires from a three-phase electrical cable enables a vessel having the vessel plug installed on its shore power cable to connect its power system to a shore power source which has no shore power cable and which ordinarily requires hard wiring a vessel's shore power cable to the shore power source by installing the one or more of the plurality of adapters to an end of a section of three-phase electrical cable and hardwiring the other end of the section of three-phase electrical cable to the shore power source; and
wherein the means to receive and secure respective ground, neutral, and L1, L2, and L3 phase wires from a three-phase electrical cable enables a vessel having the vessel plug installed on its shore power cable to connect its power system to a shore power source having a shore power source socket having an unknown configuration by installing the one or more of the plurality of adapters to an end of a section of three-phase electrical cable and installing a sourced plug compatible with the configuration of the unknown socket configuration on the other end of the three-phase electrical cable creating a custom adapter which connects to the vessel plug to the shore power source.

6. The system for providing marine shore power of claim 1, wherein the vessel plug installed on a vessel's shore power cable, along with the plurality of adapters, eliminate the need for multiple bulky and expensive cable sets or the need to rewire a vessel's shore power cable with a different plug each time a vessel berths in a marina having an unknown shore power source configuration or having a shore power source with a socket installed having configuration which is not compatible with a vessel's shore power plug configuration.

7. The system for providing marine shore power of claim 1, wherein the vessel plug installed on a vessel's shore power cable, along with the plurality of adapters, meet the needs of supplying a vessel with high amperage three-phase electricity from a shore power source regardless of the configuration of a shore power source or the configuration of a socket installed on a shore power source.

8. The system for providing marine shore power of claim 1, wherein the vessel plug installed on a vessel's shore power cable, along with the plurality of adapters, are easy to use, efficient and relatively inexpensive.

9. The system for providing marine shore power of claim 1, wherein a vessel is connected to a shore high amperage three-phase shore power source by simply plugging in one of the plurality of adapters, which is compatible to the socket used on the shore power source, into the vessel plug attached to the vessel's shore power plug.

10. A system for providing marine shore comprising:
a vessel plug having a male plug component; and
a plurality of adapters with each having a female socket component and a male adapter component;
wherein the vessel plug is intended to replace a vessel's shore power cable plug by being installed directly on a vessel's shore power cable;
wherein the male plug component of the vessel plug is compatible with and plugs into the female socket component of each of the plurality of adapters;
wherein the male adapter components are each configured differently so as to enable a vessel to connect to a shore power source regardless of the configuration of the shore power source or the configuration of any socket installed on the shore power source.

11. The system for providing marine shore power of claim 10, wherein the majority of the plurality of adapters have configurations matching known four and five pin shore power socket configurations used internationally;
wherein the majority of the plurality of adapters enable a vessel, having the vessel plug of the invention installed on its shore power cable, to connect to any shore power source socket having one of these known configurations.

12. The system for providing marine shore power of claim 10, wherein at least one or more of the plurality of adapters has a means to receive and secure respective ground, neutral, and L1, L2, and L3 phase wires of a three-phase electrical cable;
wherein the means to receive and secure respective ground, neutral, and L1, L2, and L3 phase wires from a three-phase electrical cable enables a vessel having the vessel plug installed on its shore power cable to connect its power system to a shore power source having a shore power supply cable with no socket installed;
wherein the means to receive and secure respective ground, neutral, and L1, L2, and L3 phase wires from a three-phase electrical cable enables a vessel having the vessel plug installed on its shore power cable to connect its power system to a shore power source which has no shore power cable and which ordinarily requires hard wiring a vessel's shore power cable to the shore power source by installing the one or more of the plurality of adapters to an end of a section of three-phase electrical cable and hardwiring the other end of the section of three-phase electrical cable to the shore power source; and
wherein the means to receive and secure respective ground, neutral, and L1, L2, and L3 phase wires from a three-phase electrical cable enables a vessel having the vessel plug installed on its shore power cable to connect its power system to a shore power source having a shore power source socket having an unknown configuration by installing the one or more of the plurality of adapters to an end of a section of three-phase electrical cable and installing a sourced plug compatible with the configuration of the unknown socket configuration on the other end of the three-phase electrical cable creating a custom adapter which connects to the vessel plug to the shore power source.

13. The system for providing marine shore power of claim 11, wherein one or more of the plurality of adapters has a male adapter component having a configuration which is compatible shore power source sockets which has only a ground terminal, an L1 phase terminal, an L2 phase terminal, and an L3 phase terminal.

14. The system for providing marine shore power of claim 1, wherein the vessel plug installed on a vessel's shore power cable, along with the plurality of adapters, eliminate the need for multiple bulky and expensive cable sets or the need to rewire a vessel's shore power cable with a different plug each time a vessel berths in a marina having an unknown shore power source configuration or having a shore power source with a socket installed having configuration which is not compatible with a vessel's shore power plug configuration.

15. The system for providing marine shore power of claim 10, wherein the vessel plug installed on a vessel's shore power cable, along with the plurality of adapters, meet the needs of supplying a vessel with high amperage three-phase electricity from a shore power source regardless of the configuration of a shore power source or the configuration of a socket installed on a shore power source.

16. The system for providing marine shore power of claim 10, wherein the vessel plug installed on a vessel's shore power cable, along with the plurality of adapters, are easy to use, efficient and relatively inexpensive.

17. The system for providing marine shore power of claim 10, wherein a vessel is connected to a shore high amperage three-phase shore power source by simply plugging in one of the plurality of adapters, which is compatible to the socket used on the shore power source, into the vessel plug attached to the vessel's shore power plug.
